(19) United States
(12) Patent Application Publication
(10) Pub. No.: US 2008/0160462 A1
(43) Pub. Date: Jul. 3, 2008

(54) METHOD AND SYSTEM FOR BAKE PLATE HEAT TRANSFER CONTROL IN TRACK LITHOGRAPHY TOOLS

(75) Inventors: Harald Herchen, Los Altos, CA (US); Kim Vellore, San Jose, CA (US); Erica Renee Porras, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Kyoto (JP)

(21) Appl. No.: 11/693,646

(22) Filed: Mar. 29, 2007

Related U.S. Application Data
(60) Provisional application No. 60/883,306, filed on Jan. 3, 2007.

(51) Int. Cl. G03C 5/00; H05B 3/68

(52) U.S. Cl. 430/330; 219/444.1

(57) ABSTRACT

A thermal processing module for a track lithography tool includes a bake plate comprising a process surface and a lower surface opposing the process surface. The thermal processing module also includes a plurality of electrodes coupled to the bake plate Each of the plurality of electrodes is adapted to receive a drive signal. The thermal processing module further includes a plurality of proximity pins coupled to the process surface and extending to a predetermined height from the process surface, a plurality of flexible members coupled to the lower surface of the bake plate, a chill plate coupled to the plurality of flexible members and defining a plurality of chambers, and a plurality of channels. Each of the plurality of channels is in fluid communication with one of the plurality of chambers and with one or more sources of a pressurized fluid.

### CROSS-REFERENCES TO RELATED APPLICATIONS

The present application claims benefit under 35 U.S.C. § 119(e) of U.S. Provisional Patent Application No. 60/883,306, filed Jan. 3, 2007, entitled “Method and System for Bake Plate Heat Transfer Control in Track Lithography Tools,” which is incorporated herein by reference in its entirety.

### BACKGROUND OF THE INVENTION

The present invention relates generally to the field of substrate processing equipment. More particularly, the present invention relates to a method and apparatus for operating a bake plate of a semiconductor processing apparatus. Merely by way of example, the method and apparatus of the present invention determine and compensate for substrate shape during thermal processing of the substrate in a thermal processing chamber of a track lithography tool. The method and apparatus can be applied to other processing devices for semiconductor processing equipment utilized in other processing chambers.

Modern integrated circuits contain millions of individual elements that are formed by patterning the materials, such as silicon, metal and dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to radiation that is suitable for modifying the exposed layer and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various stations of the track tool and an interface that allows the tool to be operatively coupled to a lithography exposure tool in order to transfer substrates into the exposure tool and to receive substrates after they have been processed within the exposure tool.

Over the years there has been a strong push within the semiconductor industry to shrink the size of semiconductor devices. The reduced feature sizes have caused the industry's tolerance to process variability to shrink, which in turn, has resulted in semiconductor manufacturing specifications having more stringent requirements for process uniformity and repeatability. An important factor in minimizing process variability during track lithography processing sequences is to ensure that substrate processing is performed uniformly as a function of wafer position. For example, during bake processes, it is desirable to provide uniform thermal treatment across the substrate. Because processed wafers are generally characterized by wafer bowing, achieving uniform thermal treatment is hindered by the different air gaps between the substrate and the bake plate.

Thus, there is a need in the art for improved methods and systems for measuring and compensating for substrate shape including wafer warpage during thermal processing operations.

### SUMMARY OF THE INVENTION

According to embodiments of the present invention, techniques related to the field of substrate processing equipment are provided. More particularly, the present invention relates to a method and apparatus for operating a bake plate of a semiconductor processing apparatus. Merely by way of example, the method and apparatus of the present invention determine and compensate for substrate shape during thermal processing of the substrate in a thermal processing chamber of a track lithography tool. The method and apparatus can be applied to other processing devices for semiconductor processing equipment utilized in other processing chambers.

According to an embodiment of the present invention, a method of performing a thermal process using a bake plate of a track lithography tool is provided. The bake plate is configured such that a lower surface of the bake plate is coupled to a plurality of chambers. The method includes establishing a first pressure in a first chamber of the plurality of chambers and providing a first drive signal to a first electrode in electrical communication with a process surface of the bake plate. The first electrode is associated with the first chamber. The method also includes moving a semiconductor substrate toward the process surface of the bake plate, receiving a first response signal from the first electrode, and processing the first response signal to determine a first capacitance value associated with a first gap between the first electrode and a first portion of the semiconductor substrate. The method further includes establishing a second pressure in the first chamber.

In a particular embodiment, the method additionally includes establishing a third pressure in a second chamber of the plurality of chambers and providing a second drive signal to a second electrode in electrical communication with the process surface of the bake plate. The second electrode is associated with the second chamber. The method provided by the particular embodiment further includes receiving a second response signal from the second electrode, processing the second response signal to determine a second capacitance associated with a second gap between the second electrode and a second portion of the semiconductor substrate, and establishing a fourth pressure in the second chamber.

According to another embodiment of the present invention, a thermal processing module for a track lithography tool is provided. The thermal processing module includes a bake plate comprising a process surface and a lower surface opposing the process surface and a plurality of electrodes coupled to the bake plate. Each of the plurality of electrodes is adapted to receive a drive signal. The thermal processing module also includes a plurality of proximity pins coupled to the process surface and extending to a predetermined height from the process surface and a plurality of flexible members coupled to the lower surface of the bake plate. The thermal processing module further includes a chill plate coupled to the plurality of flexible members and defining a plurality of chambers and a plurality of channels. Each of the plurality of channels is in fluid communication with one of the plurality of chambers and with one or more sources of a pressurized fluid.

According to a specific embodiment of the present invention, a bake plate system for a track lithography tool is provided. The bake plate system includes a processing system having a heater controller and a processor. The processor is adapted to output a plurality of first drive signals in a first frequency range and receive a plurality of response signals related to the plurality of first drive signals. The processor is further adapted to output a plurality of second drive signals in a second frequency range. The bake plate system also includes a bake plate having a process surface and a lower surface opposing the process surface and a plurality of independent chambers coupled to the lower surface of the bake plate. Each of the plurality of independent chambers is adapted to receive a pressurized fluid. The bake plate system further includes a plurality of electrodes coupled to the process surface. Each of the plurality of electrodes is adapted to receive one of the plurality of first drive signals from the processor and one of the plurality of second drive signals from the processor.

Many benefits are achieved by way of the present invention over conventional techniques. For example, embodiments of the present invention provide information on substrate warpage during wafer placement and provide for adjustment of the bake plate shape in response to the substrate warpage to compensate for substrate to bake plate gap variations. Moreover, some embodiments utilize a number of optical probes to determine the bake plate temperature during thermal processing steps. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of a track lithography tool according to an embodiment of the present invention;

FIG. 2 is a simplified cut-away perspective view of a thermal unit according to an embodiment of the present invention;

FIG. 3 is a perspective view of a cross-section of a bake station according to an embodiment of the present invention;

FIG. 4 is a simplified representative view of a conventional multi-zone bake plate;

FIG. 5 is a simplified plan view of a bake plate with integrated capacitive sensors according to an embodiment of the present invention;

FIG. 6A is a simplified cross-sectional schematic diagram of a bake plate system in a first state according to an embodiment of the present invention

FIG. 6B is a simplified cross-sectional schematic diagram of a bake plate system in a second state according to an embodiment of the present invention;

FIG. 7 is a simplified flowchart illustrating a method of operating a bake plate according to an embodiment of the present invention; and

FIG. 8 is a simplified schematic diagram of a bake plate system according to an embodiment of the present invention.

### DETAILED DESCRIPTION OF SPECIFIC EMBODIMENTS

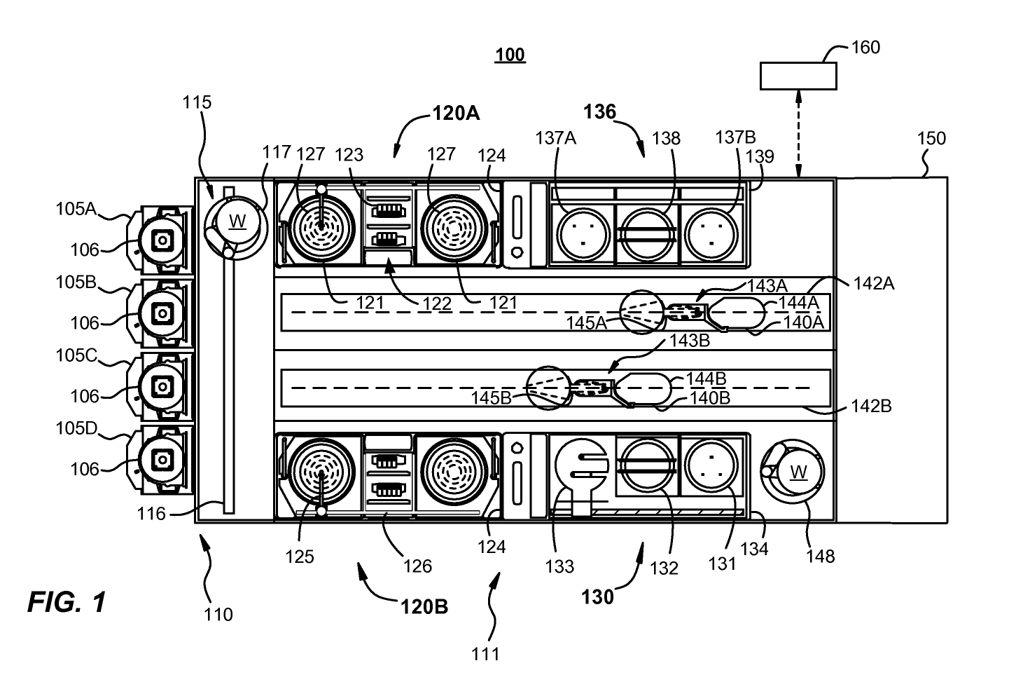

FIG. 1 is a plan view of an embodiment of a track lithography tool in which the embodiments of the present invention may be used. As illustrated in FIG. 1, the track lithography tool contains a front end module 110 (sometimes referred to as a factory interface) and a process module 111. In other embodiments, the track lithography tool includes a rear module (not shown), which is sometimes referred to as a scanner interface. Front end module 110 generally contains one or more pod assemblies or FOUPS (e.g., items 105A-D) and a front end robot assembly 115 including a horizontal motion assembly 116 and a front end robot 117. The front end module 110 may also include front end processing racks (not shown). The one or more pod assemblies 105A-D are generally adapted to accept one or more cassettes 106 that may contain one or more substrates or wafers that are to be processed in the track lithography tool. The front end module 110 may also contain one or more pass-through positions (not shown) to link the front end module 110 and the process module 111.

Process module 111 generally contains a number of processing racks 120A, 120B, 130, and 136. As illustrated in FIG. 1, processing racks 120A and 120B each include a coater/developer module with shared dispense 124. A coater/developer module with shared dispense 124 includes two coat bowls 121 positioned on opposing sides of a shared dispense bank 122, which contains a number of dispense nozzles 123 providing processing fluids (e.g., bottom anti-reflection coating (BARC) liquid, resist, developer, and the like) to a wafer mounted on a substrate support 127 located in the coat bowl 121. In the embodiment illustrated in FIG. 1, a nozzle positioning member 125 sliding along a track 126 is able to pick up a dispense nozzle 123 from the shared dispense bank 122 and position the selected dispense nozzle over the wafer for dispense operations. Coat bowls with dedicated dispense banks are provided in alternative embodiments.

Processing rack 130 includes an integrated thermal unit 134 including a bake plate 131, a chill plate 132 and a shuttle 133. The bake plate 131 and the chill plate 132 are utilized in heat treatment operations including post exposure bake (PEB), post-resist bake, and the like. In some embodiments the shuttle 133, which moves wafers in the x-direction between the bake plate 131 and the chill plate 132, is chilled to provide for initial cooling of a wafer after removal from the bake plate 131 and prior to placement on the chill plate 132. Moreover, in other embodiments shuttle 133 is adapted to move in the z-direction, enabling the use of bake and chill plates at different z-heights. Processing rack 136 includes an integrated bake and chill unit 139, with two bake plates 137A and 137B served by a single chill plate 138.

One or more robot assemblies (robots) 140 are adapted to access the front-end module 110, the various processing modules or chambers retained in the processing racks 120A, 120B, 130, and 136, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move orthogonal to the transfer direction. Utilizing one or more of three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 130, and 136. In one embodiment, to perform the process of transferring substrates in the track lithography tool, robot assembly 140A and robot assembly 140B are similarly configured and include at least one horizontal motion assembly 142, a vertical motion assembly 144, and a robot hardware assembly 143 supporting a robot blade 145. Robot assemblies 140 are in communication with a controller 160 that controls the system. In the embodiment illustrated in FIG. 1, a rear robot assembly 148 is also provided.

The scanner 150 is a lithographic projection apparatus used, for example, in the manufacture of integrated circuits. The scanner 150 exposes a photosensitive material that was deposited on the substrate in the cluster tool to some form of radiation to generate a circuit pattern corresponding to an individual layer of the integrated circuit device to be formed on the substrate surface.

Each of the processing racks 120A, 120B, 130, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

In one embodiment, controller 160 is used to control all of the components and processes performed in the cluster tool. The controller 160 is generally adapted to communicate with the scanner 150, monitor and control aspects of the processes performed in the cluster tool, and is adapted to control all aspects of the complete substrate processing sequence. The controller 160, which is typically a microprocessor-based controller, is configured to receive inputs from a user and/or various sensors in one of the processing chambers and appropriately control the processing chamber components in accordance with the various inputs and software instructions retained in the controller's memory. The controller 160 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 160 determines which tasks are performable in the processing chambers. Preferably, the program is software readable by the controller 160 and includes instructions to monitor and control the process based on defined rules and input data.

It is to be understood that embodiments of the invention are not limited to use with a track lithography tool such as that depicted in FIG. 1, but may be used in any track lithography tool including the many different tool configurations described in U.S. patent application Ser. Nos. 11/112,281 entitled “Cluster Tool Architecture for Processing a Substrate” filed on Apr. 22, 2005, and 11/315,984 entitled “Cartesian Robot Cluster Tool Architecture” filed on Dec. 22, 2005, both of which are hereby incorporated by reference for all purposes. In addition, embodiments of the invention may be used in other semiconductor processing equipment.

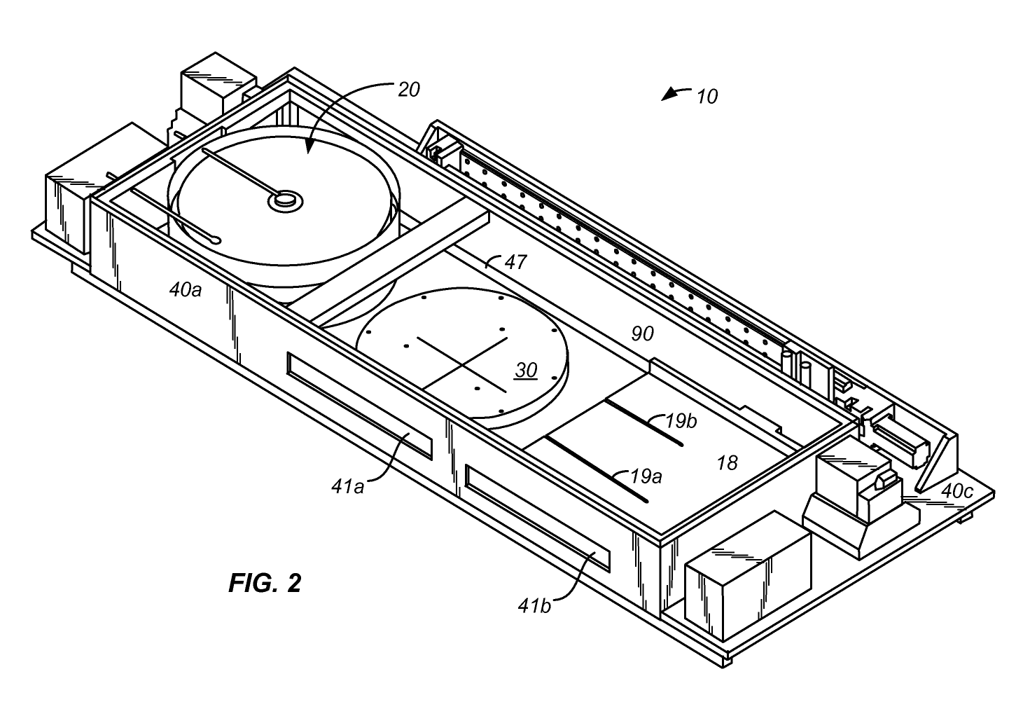

FIG. 2 is a simplified cut-away perspective view of a thermal unit according to an embodiment of the present invention. As illustrated in FIG. 2, the thermal unit 10 is shown in a cut-away view in which the top cover (not shown) is removed. The thermal unit 10 is serviced by a central robot through wafer transfer slots 41a and 41b in surface 40a. Generally, substrates enter the thermal unit through wafer transfer slot 41b and are placed on the shuttle 18, also referred to as a transfer shuttle. The shuttle delivers the substrate to the chill plate 30 and the clam shell enclosure 20 as appropriate to the particular thermal processes being performed on the substrate. The thermal unit 10 includes a shuttle 18, a chill plate 30, and clam shell enclosure 20 in which substrates are baked during portions of the lithography process. Lift pin slots 19a and 19b are provided in shuttle 18 to enable lift pins supporting the wafer to pass through the body of the shuttle. Also visible is a space 47 between rear support piece 90 of the housing and a bottom piece 40c. Space 47 extends along much of the length of thermal unit 10 to allow shuttle 18 to transfer wafers between bake and chill plates in the thermal unit.

Clam shell enclosure 20 contains a bake plate (not shown). In some embodiments, the bake plate is a multi-zone heater plate adapted to provide controlled heating to various portions of a substrate mounted on the bake plate. Additionally, some embodiments provide for a single-zone or multi-zone lid for the clam shell enclosure 20. Additional description of thermal units provided according to embodiments of the present invention is provided in co-pending and commonly assigned U.S. patent application Ser. No. 11/174,988, filed on Jul. 5, 2005 and hereby incorporated by reference in its entirety for all purposes.

Embodiments of the present invention are utilized in temperature controlled processes performed utilizing bake plates used for post-application-bake (PAB) and/or post-exposure-bake (PEB) processes. Uses are not limited to these processes as the cooling of temperature control structures are included within the scope of embodiments of the present invention. These other temperature control structures include chill plates, develop plates, and the like. One of ordinary skill in the art would recognize many variations, modifications, and alternatives.

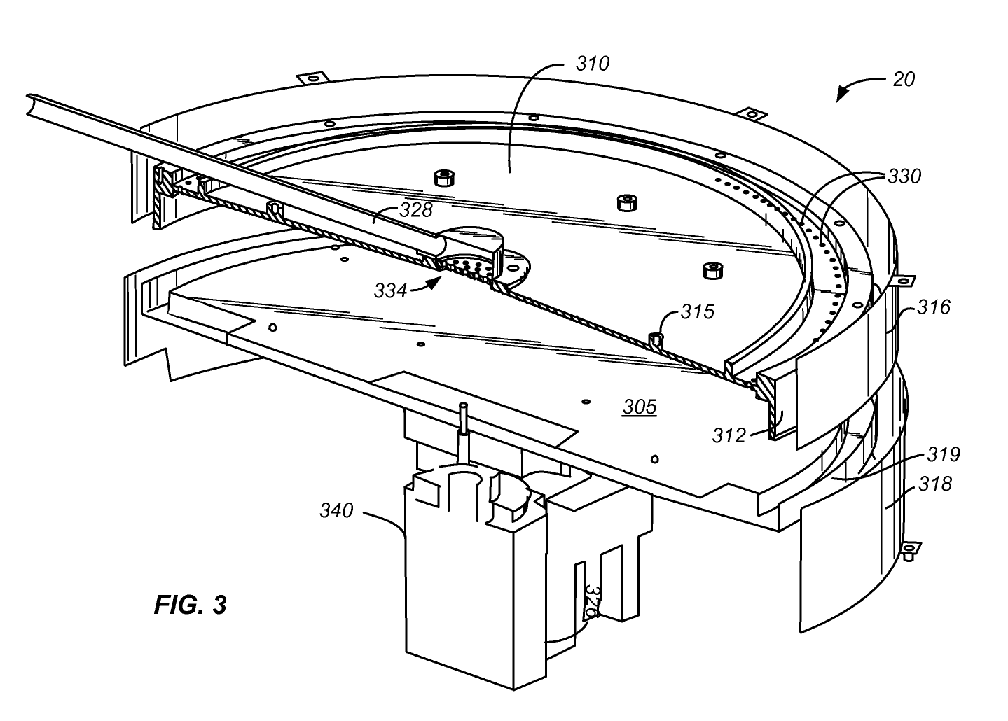

FIG. 3 is a perspective view of a cross-section of a bake station according to an embodiment of the present invention. As illustrated in FIG. 3, bake station 20 includes three separate isothermal heating elements: bake plate 305, top heat plate 310, and side heat plate 312, each of which is manufactured from a material exhibiting high heat conductivity, such as aluminum or other appropriate material. In an embodiment, each plate 305, 310, and 312 has a heating element, for example resistive heating elements, embedded within the plate. Bake plate 305 is generally fabricated from a thermally conductive material as described more fully below. It should be noted that the simplified illustration of bake plate 305 provided in FIG. 3 omits a number of elements for the purpose of clarity. Bake station 20 also includes side, top and bottom heat shields 316 and 318, respectively, as well as a bottom cup 319 that surrounds bake plate 305. In an embodiment, each of heat shields 316, 318, and cup 319 are made from aluminum. A lid (not shown) is attached to top heat plate 310 by eight screws through threaded holes 315.

Bake plate 305 is operatively coupled to a motorized lift 340 so that the bake plate can be raised into the clam shell enclosure and lowered into a wafer receiving position. Typically, wafers are heated on bake plate 305 when it is raised to a baking position. When in the baking position, cup 319 encircles a bottom portion of side heat plate 312 forming a clam shell arrangement that helps confine heat generated by bake plate 305 within an inner cavity formed by the bake plate and the enclosure. In one embodiment, the upper surface of bake plate 305 includes 8 wafer pocket buttons and 17 proximity pins. Also, in one embodiment bake plate 305 includes a plurality of vacuum ports and can be operatively coupled to a vacuum chuck to secure a wafer to the bake plate during the baking process. In another embodiment, the bake plate includes an electrostatic chuck to secure the wafer to the bake plate during the baking process.

Gas is initially introduced into bake station 20 at an annular gas manifold 326 that encircles the outer portion of top heat plate 310. Gas manifold 326 includes numerous small gas inlets 330 (128 inlets in one embodiment) that allow gas to flow from manifold 326. After flowing through the station, gas exits bake station 20 through exhaust manifold 334 and gas outlet line 328.

Bake plate 305 heats a wafer according to a particular thermal recipe. One component of the thermal recipe is typically a set point temperature at which the bake plate is set to heat the wafer. During the baking process, embodiments of the present invention measure the gap between the wafer and the bake plate at a number of locations across the bake plate. Based on these gap measurements, the shape of the bake plate is adjusted to ensure uniform heating of the substrate. Additional description of the methods and systems utilized to operate the bake plate are provided throughout the present specification and more particularly below.

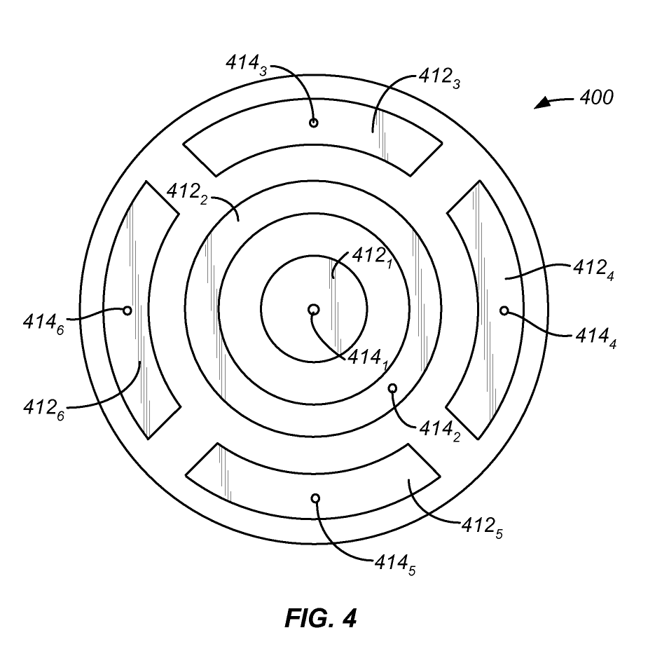

FIG. 4 is a simplified representative view of a conventional multi-zone bake plate. As illustrated in FIG. 4, the bake plate includes six different electrically independently heating zones. Referring to FIG. 1, bake plate 400 includes six independent heater zones 412₁-412₆ along with a corresponding number of temperature sensors 414₁-414₆, one for each of the heater zones 412₁-412₆.

In some conventional systems utilized to estimate a wafer warpage profile during thermal processing, the bake plate temperature profiles are monitored within each of the bake plate zones. Because the various vertical air gaps between the warped wafer and the multi-zone bake plate are characterized by different heat transfer rates, the air gaps can be extracted from temperature readings obtained in each of the zones. Thus, in these conventional techniques, using first-principles thermal modeling and system identification techniques, an estimate of the profile of the warped wafer can be obtained. A drawback of using these conventional techniques is that the time required to determine the wafer warpage is a function of the thermal transfer rates, typically resulting in measurement times on the order of several to tens of seconds. In other words, the variations in thermal transfer rates across the bake plate, which are computed using temperature readings from thermal sensors in the bake plate, are only determined slowly, placing limits on the temporal response of such a measurement system.

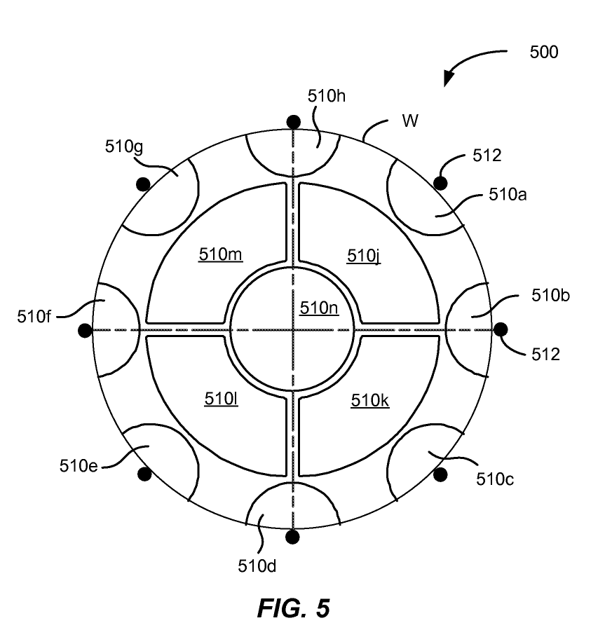

FIG. 5 is a simplified plan view of a bake plate with integrated capacitive sensors according to an embodiment of the present invention. Referring to FIG. 5, the bake plate with integrated capacitive sensors 500 includes a number of electrodes 510 adjacent the mechanical stops 512, which form a wafer pocket for wafer W. The mechanical stops or protrusions (bosses) 512 extend from the surface of the bake plate and provide a mechanical limiting function to arrest horizontal sliding motion of the substrate. Generally, the mechanical stops are tapered and can be made from any appropriate material, such as a thermoplastic material, that exhibit strong fatigue resistance and thermal stability. In one embodiment, mechanical stops 512 are made from polyetheretherketone, which is also known as PEEK. In the embodiment illustrated in FIG. 5, eight mechanical stops 512 are utilized to form the wafer pocket, which has an inner diameter equal to the wafer diameter.

A number of electrodes 510 are provided on the bake plate and utilized to provide capacitance measurements as described more fully below. In the embodiment illustrated in FIG. 5, eight electrodes 510a-510h are provided in association with the eight mechanical stops 512. The electrodes 510 are in electrical communication with control electronics (not shown) used to provide electrical signals to the electrodes. The electrodes 510 are typically deposited or otherwise formed on the upper surface of the bake plate, which is fabricated from a thermally conductive material. By way of example, bake plates may be fabricated from aluminum nitride, stainless steel, copper, graphite, aluminum, ceramics, combinations of these, and the like. As will be evident to one of skill in the art, electrical isolation is provided between the electrodes 510 and other portions of the bake plate, which may be electrically conductive as well as thermally conductive.

As a substrate is placed on the bake plate, the electrodes 510 capacitively couple to the substrate as the substrate settles onto the bake plate. The spatial positioning of the electrodes 510a-510h is selected to position each of the electrodes adjacent one of the mechanical stops 512. Thus, as the substrate settles onto the bake plate, the electrodes 510a-510h are positioned to provide capacitive coupling data for eight peripheral positions of the substrate. In addition to electrodes 510a-510h, which are located to align with peripheral portions of the substrate, additional electrodes 510j-510n are provided at interior portions of the bake plate. Accordingly, electrodes 510j-510n are located to align with interior portions of the substrate.

In an embodiment, the electrodes 510 are formed using heater elements present in the bake plate 500. For example, the electrodes 510 as illustrated in FIG. 5 may be defined by resistive heating elements present either on the top surface of the bake plate 500 or at an internal layer of the bake plate 500. As described more fully below, in these embodiments, the capacitively coupled measurement signals are provided in a first frequency band and control signals for the heater elements are provided in a second frequency band. Thus, the single electrical structure of the heater elements is utilized to provide control signals for the heaters and capacitance coupling measurement signals utilized to determine wafer shape.

In yet other embodiments, multiple elements are utilized to form the electrodes 510 and the heater elements. For example, in some applications, the heater elements are embedded in a dielectric material, such as a Kapton® polyimide film. In these applications, electrical connections for the electrodes and heater elements are provided separately as they pass through the dielectric layers as will be evident to one of skill in the art.

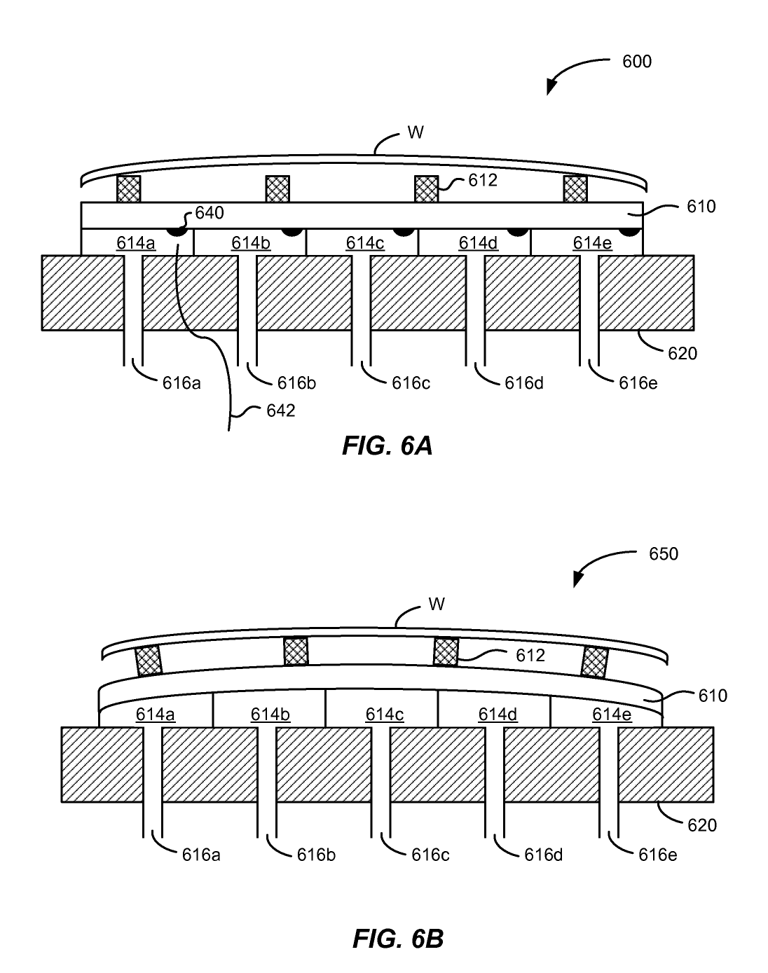

FIG. 6A is a simplified cross-sectional schematic diagram of a bake plate system in a first state according to an embodiment of the present invention. The wafer W is illustrated in FIG. 6A as bowed with a concave downward profile. Other wafer profiles are also included within the scope of embodiments of the present invention and the wafer profile illustrated in FIG. 6A is provide merely by way of example. The bake plate system includes bake plate 610, a number of proximity pins 612 disposed on the upper surface of the bake plate, and a number of independent chambers 614 coupled to the lower surface of the bake plate. The proximity pins 612 extend to a predetermined height above the process surface of the bake plate, typically 100 μm±10 μm. In other embodiments, other proximity pin heights are utilized. Because of the wafer bowing, the wafer makes contact with the proximity pins 612 at the periphery of the bake plate 610, but not at interior portions of the bake plate. Accordingly, the gap between the bake plate 610 and the wafer W is not constant as a function of position, with a larger gap at central portions of the wafer. As a result of the differing gaps as a function of wafer position, uniform bake plate temperature will not generally result in uniform wafer heating, impacting process uniformity and the like.

Five independent chambers 614a, 614b, 614c, 614d, and 614e are illustrated in FIG. 6A, but it will be appreciated that the number, dimensions, two-dimensional layout, and the like will depend on the particular application. Each of the independent chambers 614a-614e are in fluid communication with a duct 616a-616e, respectively. Ducts 616 are in fluid communication with one or more sources of vacuum pressure, atmospheric pressure, or pressure greater than atmospheric pressure. For purposes of clarity, the various pumps, valves, and other equipment providing the vacuum and/or pressurized gas are not illustrated in FIG. 6A.

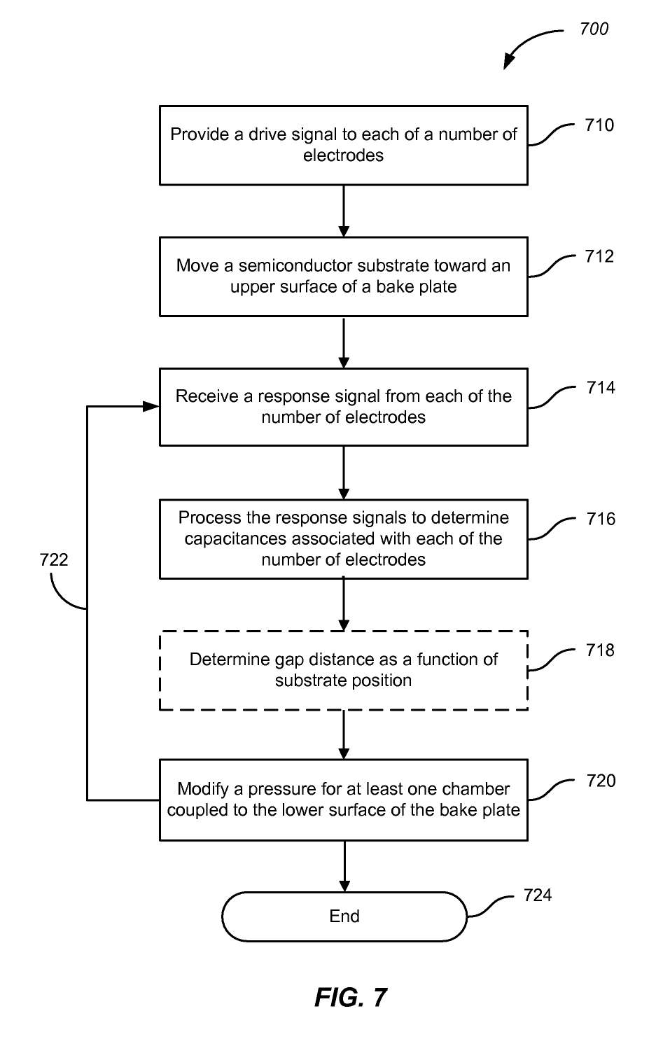

Bowing of wafer W is measured using the apparatus described in relation to FIG. 5 and the technique described in relation to FIG. 7 or other suitable apparatuses techniques. In order to compensate for the bowing of wafer W, the shape of the bake plate is modified using appropriate pressures in chambers independent chambers 614a-614e. The chambers 614 are sealed regions coupled to the lower surface of the bake plate that are provided with adjustable pressure. Flexible dividers are used to connect the bake plate 610 to the chill plate 620. Depending on the wafer shape, each of the portions of the bake plate adjacent the independent chambers is either pushed up, pulled down, or maintained in a neutral position. Thus, embodiments of the present invention contrast with conventional approaches that use either ceramic or metal plates fabricated to maintain a flat bake plate surface during processing and over the life of the plate. Generally, such ceramic plates are characterized by a thickness of about 8-15 times the wafer thickness. By using gas pressure to deform the bake plate, for example, pressurized air, the deformation force is spread out substantially uniformly over each of the portions of the bake plate. In other embodiments, other mechanical or magnetic forces are utilized to provide for bake plate deformation. One of ordinary skill in the art would recognize many variations, modifications, and alternatives.

FIG. 6B is a simplified cross-sectional schematic diagram of a bake plate system in a second state according to an embodiment of the present invention. As the pressure in the central chambers is increased, for example, chamber 614c, the bake plate deforms, bending up at the center to approach the wafer W. In order to bring the central proximity pins into contact with the lower surface of the wafer, the measurements of wafer bowing are utilized in deforming the bake plate surface until the proximity pins are brought into contact with the wafer. Appropriate pressures are independently applied to each of the chambers 614 based on the wafer bowing measurements. Further measurements of the wafer shape may be made, adjusting the bake plate shape in a feedback loop.

Although FIG. 6B illustrates bowing of the wafer in a concave downward direction and matching deformation of the bake plate surface, this is not required by embodiments of the present invention. In other embodiments, wafer shapes include saddle-shaped, concave upwards, and the like. Thus, by providing a sufficient number of sensors and corresponding pressure zones (e.g., six to eight), the bake plate can conform to the typical wafer shapes that occur in semiconductor manufacturing. Accordingly, the bake plate is deformed by the application of pressure or vacuum to various independent chambers that raise or lower local portions of the bake plate surface in response to the wafer shape. After deformation, the gap distance between the bake plate surface and the wafer is substantially uniform across the wafer, enabling for uniform heat transfer between the bake plate and the wafer as a function of position.

The materials and dimensions of the bake plate are selected in embodiments of the present invention to provide for the flexibility illustrated in FIG. 6B. Thus, embodiments of the present invention utilize a thin bake plate with the ability to warp in response to the pressure changes in the chambers and thereby conform to the wafer profile. Because the measurement of the wafer shape and corresponding deformation may be performed in real-time (i.e., on the fly), the gap between the wafer and the bake plate may be maintained at a uniform distance independent of process length. Additionally, for wafers that are bowed slightly differently with a single lot, wafer shape compensation is provided, thereby providing a uniform temperature profile throughout the lot. The contact between the backside of the wafer and the bake plate surface is preferably limited to contact at the proximity pins, reducing the likelihood of backside particle generation.

In a particular embodiment, the bake plate comprises a relatively thin plate of thermally conductive material such as aluminum nitride, stainless steel, copper, graphite, aluminum, other metals, ceramics such as pyrolytic boron nitride (PBN), pyrolytic graphite, composites of carbon fiber and silica, composites of carbon fiber and epoxy, combinations thereof, and the like. Electrodes are fabricated for use in wafer shape measurement, and the independent chambers are fluidly connected to gas sources to provide a variable and controllable force below the bake plate. In an embodiment, the thickness of the bake plate is a predetermined value that provides for sufficient flexibility to conform to the local shape variations in the substrate. For example, in an embodiment, the thickness of the bake plate is about 2 mm. In other embodiments, the thickness ranges from about 1 mm to about 3 mm. Of course, the particular thickness will depend on the particular application.

In an embodiment, the bake plate is fabricated from a material characterized by an anisotropic thermal conductivity material (i.e., the horizontal thermal conductivity is greater than the vertical thermal conductivity). The use of such materials will reduce the impact of vertically directed airflow onto the bake plate. In a particular embodiment, the bake plate is fabricated from a material with a thermal conductivity of approximately 30:1 measured in the horizontal:vertical directions. PBN is an example of a ceramic material providing such an anisotropic thermal conductivity. Pyrolytic graphite is another example of a material providing such an anisotropic thermal conductivity. In some embodiments, pyrolytic graphite is used in which the ratio of the anisotropic thermal conductivity is modified to meet design specifications.

In yet another embodiment, one or more portions of the bake plate are fabricated from pyrolytic graphite coated with either PBN, SiC, other suitable coatings, or a combination thereof. Such a structure provides the bulk properties of pyrolytic graphite and the surface properties of the coating layer. It is likely that such a structure could reduce the impact of particle shedding, which may be present using pyrolytic graphite. Typically, the thickness of the coating layer is set at a predetermined thickness such that the coating only alters the surface properties of the bake plate. Deposition by CVD or other deposition techniques is included within embodiments of the present invention.

In comparison with conventional bake plates, which utilize materials with isotropic thermal conductivities, the anisotropic thermal conductivity provided by embodiments described herein allows a thermal load or cooling due to air blowing onto the lower surface of the bake plate to be spread out by a factor of 30 times the thickness of the bake plate before reaching the wafer. In conventional bake plates, the penetration of thermal variation towards the wafer is uniform as a function of direction, which may result in a greater wafer temperature deviation in applications utilizing thin bake plates.

Referring to FIG. 6A again, the bake plate system 600 includes a chill plate 620 that is adapted to be engageably coupled to the lower surface of the bake plate 610. During or after a substrate baking process, suction can be applied to each of the independent chambers 614, pulling down the lower surface of the bake plate to make contact with the chill plate 620. The flexible dividers between adjacent chambers may include a portion recessed into the chill plate to enable the bake plate to contact the chill plate across the lower surface of the bake plate. Thus, rapid cooling of the bake plate can be accomplished, rapidly cooling the bake plate without particles from the cooling process reaching the wafer W. The use of chill plate 620 provides for particle-free cooling of the bake plate, either through convective cooling across the independent chamber 614 or conductive cooling when the chill plate is brought into physical contact with the lower surface of the bake plate. If a wafer is supported by the bake plate 610, the temperature of the substrate may be reduced. During some processing steps, such as PEB, rapid cooling of the substrate is used to uniformly and quickly quench the chemical reactions occurring in chemically amplified photoresists. Additionally, the use of the chill plate 620 allows for buffering of the bake plate against larger horizontal variations in the temperature of the bake plate than in conventional designs.

As an example, the chill plate 620 may be chilled to a few degrees below the temperature of the bake plate. In this example, thermal transfer from the chill plate to the bottom of the bake plate provides a steady loss of heat from the bake plate, allowing a larger variation between zones to occur. If the chill plate is chilled below the activation temperature of the photoresist and below the temperature where appreciable diffusion of the acid in the photoresist occurs (typically about 70° C.), then the bake plate and a supported wafer can be pulled down towards the chill plate for cooling. Moreover, heaters in certain bake plate zones can be turned on in regions where the bake plate is bowed and therefore closer to the chill plate than other regions.

Referring once again to FIG. 6A, a number of optical probes 640 are disposed on the lower surface of the bake plate 610. The optical probes 640 are fabricated from materials characterized by temperature dependent optical properties. Preferably, optical probes 640 have a low thermal mass and are interrogated using an optical fiber 642. A single optical fiber is illustrated in FIG. 6A for purposes of clarity, although generally, an optical fiber will be provided to each of the optical probes or shared between multiple optical probes. In an embodiment, the optical probe is a fluorescent material in which the wavelength of the fluorescent signal is a function of temperature. Optical radiation at a first wavelength is emitted from the optical fiber and excites the optical probe, which produces fluorescence at a second wavelength, which is collected by the optical fiber. The wavelength of the fluorescence is correlated with the temperature of the bake plate. Various optical elements, including lasers, detectors, beam splitters, lenses, and the like are not illustrated for purposes of clarity. One of ordinary skill in the art would recognize many variations, modifications, and alternatives.

In another embodiment utilizing fluoroptic temperature measurements, multiplexed optical fibers are employed to reduce system costs. Embodiments of the present invention contrast with conventional designs in which RTDs, which are relatively bulky and have leads that can cause temperature variation due to thermal losses in the leads, are utilized. Embodiments of the present invention provide a number of advantages including reduced thermal response time as a result, in part, of the low thermal mass of the optical probes, the ability to replace the bake plate without having to recalibrate RTDs, and multiplexing to provide a greater number of temperature readings with a small number of lasers and/or fluorescence decay detectors. As an example, one embodiment utilizes a read-out unit that can read 100 readings per second. Thus, even if half that time is used (on average) to optically move from one cable to the next, then 10 sensors will provide a reading every 200 milliseconds, which is generally sufficient for thermal control of the thermal processing system.

FIG. 7 is a simplified flowchart illustrating a method of operating a bake plate according to an embodiment of the present invention. The method 700 includes providing a drive signal to each of a number of electrodes (710). Generally, the drive signal is an oscillatory electrical signal of a predetermined frequency. In an embodiment, the predetermined frequency is greater than 0.1 kHz. In other embodiments, the predetermined frequency ranges from about 0.1 kHz to about 100 kHz. Of course, the particular frequency of the drive signal will depend on the particular application, including electrode geometry and the like.

A semiconductor substrate is moved toward the upper surface of the bake plate (712) and a response signal from each of the number of electrodes is received (714). As the substrate is moved toward the bake plate, the decreasing distance between the substrate and the bake plate will result in a variation in the capacitive coupling between the substrate and the electrodes 510. As a result, the response signal from each of the electrodes will be a function of the local separation between the particular electrode and the portion of the substrate above that particular electrode. The response signals are processed to determine capacitances associated with each of the electrodes (716).

Generally, the response signal is modulated in phase and amplitude by the proximity of the wafer to the particular electrode. Thus, a phase locked loop can be utilized to rapidly measure changes in the capacitance by computing phase and amplitude differences between the drive signal and the response signal. In optional step 718, the gap between each of the electrodes and the portion of the substrate opposite each of the electrodes is determined. Generally, this computation includes converting the measured capacitance values into local gap distances. Thus, as the wafer approaches the bake plate, vertical wafer to electrode distances as a function of position are measured utilizing embodiments the present invention. A benefit provided by embodiments of the present invention is the response time achievable using capacitively coupled electrodes. Conventional approaches, which utilize resistive thermal devices (RTDs) buried in the bake plate, provide much slower response times. As described more fully below, embodiments the present invention provide for repetition of a number of the steps illustrated in FIG. 7 as the wafer is placed on the bake plate. Such operations utilizing rapid response times are not available utilizing conventional techniques characterized by slower response times.

For a non-flat wafer, the gap measurements will vary as a function of position. Portions of the bake plate that are characterized by a larger gap distance will be provided with a modified chamber pressure (720) in order to increase or decrease the gap distance as appropriate. Thus, regions with a larger gap distance will receive an increase chamber pressure, thereby reducing the local gap distance. Regions with smaller gap distances will receive a reduced chamber pressure, thereby increasing the local gap distance. Steps 714 through 720 are repeated (722) until variations in the gap distance stabilize at a predetermined level. Thus, based on the measurements of the wafer shape, modifications are made in the shape of the bake plate as a function of position, compensating for wafer warpage.

As will be evident to one of skill in the art, improved control over thermal transfer between the bake plate and the substrate translates into improved critical dimension (CD) control, which is of significant benefit to semiconductor fabrication facilities. As discussed above, in comparison with conventional techniques that provide a slow response time as a result of the use of RTDs, the methods provided herein provide rapid response times, enabling rapid modifications of the bake plate shape and the local heat transfer rate. Once the wafer is positioned on the proximity pins of the bake plate, method 700 is terminated at step 724.

It should be appreciated that the specific steps illustrated in FIG. 7 provide a particular method of operating a bake plate according to an embodiment of the present invention. Other sequences of steps may also be performed according to alternative embodiments. For example, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

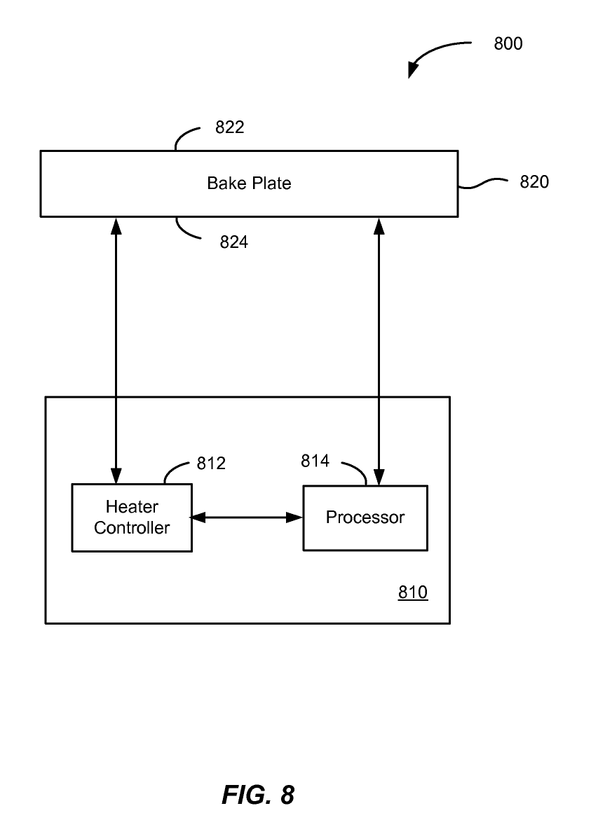

FIG. 8 is a simplified schematic diagram of a bake plate system according to an embodiment of the present invention. Referring to FIG. 8, the bake plate system includes

According to a specific embodiment of the present invention, a bake plate system for a track lithography tool is provided. The bake plate system 800 includes a processing system 810 having a heater controller 812 and a processor 814. The processor 814 is adapted to output a plurality of first drive signals in a first frequency range and receive a plurality of response signals related to the plurality of first drive signals. The processor 814 is further adapted to output a plurality of second drive signals in a second frequency range. The bake plate system also includes a bake plate 820 having a process surface 822 and a lower surface 824 opposing the process surface. As shown in FIG. 6, the bake plate includes a plurality of independent chambers 614 coupled to the lower surface of the bake plate. Each of the plurality of independent chambers is adapted to receive a pressurized fluid. As shown in FIG. 5, the bake plate system further includes a plurality of electrodes 510 coupled to the process surface. Each of the plurality of electrodes is adapted to receive one of the plurality of first drive signals from the processor and one of the plurality of second drive signals from the processor.

For purposes of clarity, other elements of the bake plate system are not illustrated. These additional elements include, without limitation, optical probes and optical fibers coupled to the optical probes. It is understood that the various functional blocks otherwise referred to herein as processors, including those shown in FIG. 8, may be included in one or more general purpose processors configured to execute instructions and data. In some embodiments, such blocks may be carried out using dedicated hardware such as an application specific integrated circuit (ASIC). In yet other embodiments, such blocks and the processing of the signals to and from the bake plate may be carried out using a combination of software and hardware. As an example, such processors include dedicated circuitry, ASICs, combinatorial logic, other programmable processors, combinations thereof, and the like. Thus, processors as provided herein are defined broadly and include, but are not limited to signal processors adapted to process capacitance and other signals. One of ordinary skill in the art would recognize many variations, modifications, and alternatives.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A method of performing a thermal process using a bake plate of a track lithography tool, wherein a lower surface of the bake plate is coupled to a plurality of chambers, the method comprising:
establishing a first pressure in a first chamber of the plurality of chambers;
providing a first drive signal to a first electrode in electrical communication with a process surface of the bake plate, wherein the first electrode is associated with the first chamber;
moving a semiconductor substrate toward the process surface of the bake plate;
receiving a first response signal from the first electrode;
processing the first response signal to determine a first capacitance value associated with a first gap between the first electrode and a first portion of the semiconductor substrate; and
establishing a second pressure in the first chamber.

2. The method of claim 1 wherein establishing the second pressure in the first chamber increases the first gap between the first electrode and the first portion of the semiconductor substrate.

3. The method of claim 1 wherein establishing the second pressure in the first chamber decreases the first gap between the first electrode and the first portion of the semiconductor substrate.

4. The method of claim 1 further comprising:
establishing a third pressure in a second chamber of the plurality of chambers;
providing a second drive signal to a second electrode in electrical communication with the process surface of the bake plate, wherein the second electrode is associated with the second chamber;
receiving a second response signal from the second electrode;
processing the second response signal to determine a second capacitance associated with a second gap between the second electrode and a second portion of the semiconductor substrate; and
establishing a fourth pressure in the second chamber.

5. The method of claim 4 wherein the first pressure is equal to the third pressure.

6. The method of claim 4 wherein the first portion of the semiconductor substrate is adjacent to the second portion of the semiconductor substrate.

7. The method of claim 1 wherein the first electrode spatially overlaps with at least a portion of the first chamber.

8. The method of claim 1 wherein the drive signal comprises an oscillatory signal.

9. The method of claim 8 wherein the oscillatory signal is characterized by a frequency greater than or equal to 0.1 kHz.

10. The method of claim 1 wherein the first response signal is shifted in at least one of phase or amplitude with respect to the first drive signal.

11. The method of claim 1 wherein the first portion of the semiconductor substrate comprises an area of the semiconductor substrate opposing the first electrode.

12. The method of claim 1 wherein establishing the second pressure in the first chamber causes the lower surface of the bake plate to make physical contact with a cooling surface of a chill plate.

13. The method of claim 12 wherein the second pressure is less than an atmospheric pressure.

14. A thermal processing module for a track lithography tool, the thermal processing module comprising:
a bake plate comprising a process surface and a lower surface opposing the process surface;
a plurality of electrodes coupled to the bake plate, wherein each of the plurality of electrodes is adapted to receive a drive signal;
a plurality of proximity pins coupled to the process surface and extending to a predetermined height from the process surface;
a plurality of flexible members coupled to the lower surface of the bake plate;
a chill plate coupled to the plurality of flexible members and defining a plurality of chambers; and
a plurality of channels, each of the plurality of channels being in fluid communication with one of the plurality of chambers and with one or more sources of a pressurized fluid.

15. The thermal processing module of claim 14 wherein each of the plurality of chambers is associated with one of the plurality of electrodes.

16. The thermal processing module of claim 14 wherein the plurality of chambers comprise a plurality of honeycombed hexagons.

17. The thermal processing module of claim 14 further comprising a plurality of mechanical stops disposed on the process surface.

18. The thermal processing module of claim 14 wherein the plurality of electrodes are electrically coupled to the process surface of the bake plate.

19. The thermal processing module of claim 14 wherein the bake plate comprises pyrolytic boron nitride.

20. The thermal processing module of claim 14 wherein a thickness of the bake plate is less than 2.5 mm.

21. The thermal processing module of claim 20 wherein the thickness of the bake plate is approximately 1.5 mm.

22. The thermal processing module of claim 14 wherein the pressurized fluid comprises a gas.

23. The thermal processing module of claim 22 wherein the gas comprises air.

24. A bake plate system for a track lithography tool, the bake plate system comprising:
a processing system comprising:
a heater controller; and
a processor adapted to:
output a plurality of first drive signals in a first frequency range;
receive a plurality of response signals related to the plurality of first drive signals; and
output a plurality of second drive signals in a second frequency range; and
a bake plate comprising:
a process surface and a lower surface opposing the process surface;
a plurality of independent chambers coupled to the lower surface of the bake plate, wherein each of the plurality of independent chambers is adapted to receive a pressurized fluid; and
a plurality of electrodes coupled to the process surface, wherein each of the plurality of electrodes is adapted to receive one of the plurality of first drive signals from the processor and one of the plurality of second drive signals from the processor.

25. The bake plate system of claim 24 further comprising a chill plate adapted to contact the lower surface of the bake plate.

26. The bake plate system of claim 24 further comprising a plurality of optical probes coupled to the lower surface of the bake plate.

27. The bake plate system of claim 26 further comprising one or more optical fibers adapted to transmit optical radiation to at least one of the plurality of optical probes and to receive a fluorescent signal from the at least one of the plurality of optical probes.
